(19) United States
(12) Patent Application Publication
(10) Pub. No.: US 2023/0052418 A1
(43) Pub. Date: Feb. 16, 2023

(54) DYNAMIC EXPANSION AND CONTRACTION OF EXTENDED REALITY ENVIRONMENTS

(71) Applicant: AT&T Intellectual Property I, L.P., Atlanta, GA (US)

(72) Inventors: Eric Zavesky, Austin, TX (US); James Pratt, Round Rock, TX (US)

(21) Appl. No.: 17/403,795

(22) Filed: Aug. 16, 2021

(51) Int. Cl. G06F 3/01

(52) U.S. Cl. CPC G06F 3/011

(57) ABSTRACT

In one example, a method performed by a processing system including at least one processor includes rendering an extended reality environment, monitoring social interactions of a plurality of users within the extended reality environment, adjusting the extended reality environment in response to the social interactions of the plurality of users, and adjusting a rule associated with the extended reality environment in response to the adjusting the extended reality environment.

The present disclosure relates generally to extended reality (XR) systems, and relates more particularly to devices, non-transitory computer-readable media, and methods for dynamically expanding and contracting XR social environments.

### BACKGROUND

Extended reality (XR) is an umbrella term that has been used to refer to various different forms of immersive technologies, including virtual reality (VR), augmented reality (AR), mixed reality (MR), cinematic reality (CR), and diminished reality (DR). Generally speaking, XR technologies allow virtual world (e.g., digital) objects to be brought into “real” (e.g., non-virtual) world environments and real world objects to be brought into virtual environments, e.g., via overlays or other mechanisms. XR technologies may have applications in fields including architecture, sports training, medicine, real estate, gaming, television and film, engineering, travel, and others. As such, immersive experiences that rely on XR technologies are growing in popularity.

### SUMMARY

In one example, the present disclosure describes a device, computer-readable medium, and method for enhancing social engagement among users in extended reality (XR) social environments by dynamically expanding and contracting the XR social environments. For instance, in one example, a method performed by a processing system including at least one processor includes rendering an extended reality environment, monitoring social interactions of a plurality of users within the extended reality environment, adjusting the extended reality environment in response to the social interactions of the plurality of users, and adjusting a rule associated with the extended reality environment in response to the adjusting the extended reality environment.

In another example, a non-transitory computer-readable medium stores instructions which, when executed by a processing system, including at least one processor, cause the processing system to perform operations. The operations include rendering an extended reality environment, monitoring social interactions of a plurality of users within the extended reality environment, adjusting the extended reality environment in response to the social interactions of the plurality of users, and adjusting a rule associated with the extended reality environment in response to the adjusting the extended reality environment.

In another example, a device includes a processing system including at least one processor and a computer-readable medium storing instructions which, when executed by the processing system, cause the processing system to perform operations. The operations include rendering an extended reality environment, monitoring social interactions of a plurality of users within the extended reality environment, adjusting the extended reality environment in response to the social interactions of the plurality of users, and adjusting a rule associated with the extended reality environment in response to the adjusting the extended reality environment.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure may operate;

FIG. 2 illustrates a flowchart of an example method for dynamically expanding and contracting extended reality social environments in accordance with the present disclosure; and

FIG. 3 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure enhances social engagement among users in extended reality (XR) social environments by dynamically expanding and contracting the XR social environments. As discussed above, XR technologies allow virtual world (e.g., digital) objects to be brought into “real” (e.g., non-virtual) world environments and real world objects to be brought into virtual environments, e.g., via overlays or other mechanisms. When the XR environment comprises a primarily virtual environment, the XR environment may be rendered in any size to accommodate any number of users. In many social XR environments, however, users may come and go; thus, the number of users is not static, but may increase or decrease over time, sometimes dramatically. Moreover, activities driven by interaction among the users may, over time, place varying physiological demands on a social XR environment.

For instance, a social XR environment may be rendered as a virtual escape room (e.g., a game in which a team of players discover clues, solve puzzles, and accomplish tasks in order to accomplish a specific goal, typically to escape the space in which the game takes place, in a limited amount of time). However, if a team of nine players wants to enter a virtual escape room that is designed for teams of four players, and if communication patterns among the players start to split at seven players, splitting of the virtual environment to accommodate nine players in a fair and inclusive manner may be difficult.

In another example, a social XR environment may be rendered as a virtual party in which attendees are encouraged to socialize with each other within one or more virtual “rooms.” However, some attendees may be reluctant to socialize, and may move to or remain in certain spaces within the XR environment in order to avoid socializing with other attendees. In this case, it may be desirable to limit access to certain spaces within the virtual environment, or even to limit expansion of the virtual environment (e.g., addition or opening of new “rooms”) in order to encourage more socialization.

Examples of the present disclosure provide analytics and automated mechanisms for dynamically expanding and contracting social XR environments. In particular, examples of the present disclosure may monitor the number of users present in a social XR environment and the interactions among those users, and may apply a set of predefined rules in order to determine when aspects of the social XR environment should be adjusted to accommodate the current number of users and/or interaction patterns. The rules may take into account considerations such as the number of users in the XR environment, the type of activity in which the users are engaged in the social XR environment, physiological constraints of the activity, and social norms associated with the activity to determine, at any time, the appropriate size and scope of the social XR environment.

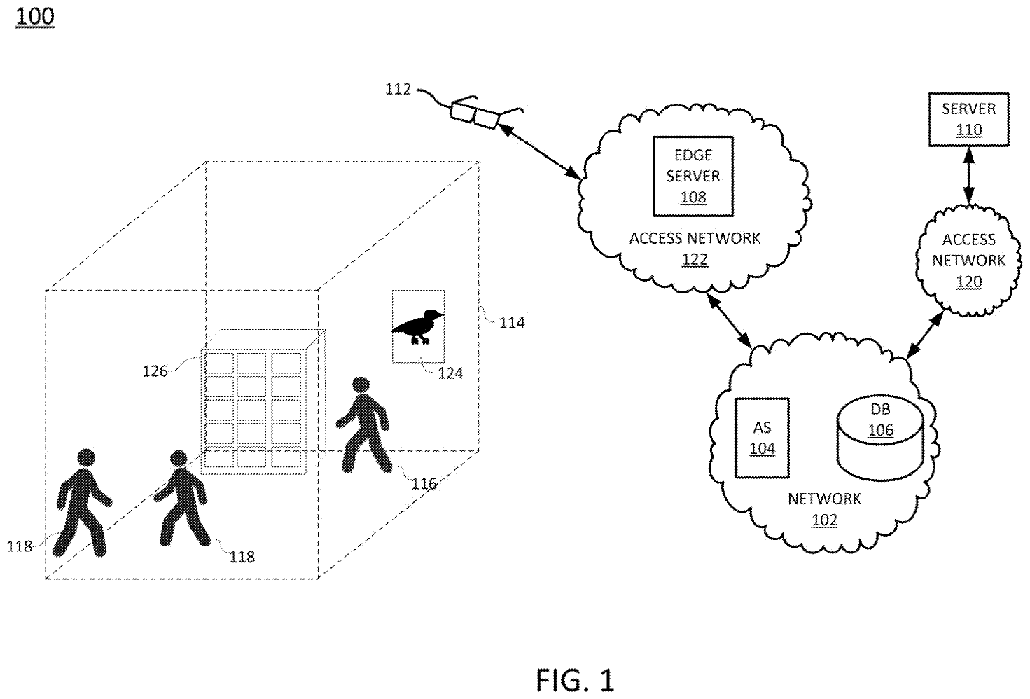

The adjustments may include adjusting the size of the social XR environment (e.g., expanding or contracting the social XR environment), adjusting a number of objects present in the social XR environment (e.g., adding or deleting virtual objects with which the users may interact), and/or adjusting the type of the social XR environment (e.g., formal, casual, professional, etc.). In further examples still, the ambience of the social XR environment could be adjusted by adjusting the audio (e.g., background music), brightness of the lighting, and the like. On a global level, the adjustments may be applied in a consistent manner, for all users of the XR environment. However, in some examples, the adjustments may be varied or adapted for specific groups of users. These and other aspects of the present disclosure are described in greater detail below in connection with the examples of FIGS. 1-3.

Within the context of the present disclosure, a “social XR environment” is understood to refer to an XR environment that is designed to encourage or facilitate interaction among a plurality of users in the XR environment. For instance, as discussed above, the social XR environment may comprise a virtual escape room or a virtual party. The social XR environment could also comprise a virtual professional conference or networking event, a virtual meeting, a virtual concert or sporting event, a virtual class, a virtual life event (e.g., wedding, bar or bat mitzvah, etc.), or another type of event. In one example, the social XR environment is an XR environment in which the number of users can change dynamically.

To further aid in understanding the present disclosure, FIG. 1 illustrates an example system 100 in which examples of the present disclosure may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, and the like), a long term evolution (LTE) network, 5G and the like related to the current disclosure. It should be noted that an IP network is broadly defined as a network that uses Internet Protocol to exchange data packets. Additional example IP networks include Voice over IP (VoIP) networks, Service over IP (SoIP) networks, and the like.

In one example, the system 100 may comprise a network 102, e.g., a telecommunication service provider network, a core network, or an enterprise network comprising infrastructure for computing and communications services of a business, an educational institution, a governmental service, or other enterprises. The network 102 may be in communication with one or more access networks 120 and 122, and the Internet (not shown). In one example, network 102 may combine core network components of a cellular network with components of a triple play service network; where triple-play services include telephone services, Internet or data services and television services to subscribers. For example, network 102 may functionally comprise a fixed mobile convergence (FMC) network, e.g., an IP Multimedia Subsystem (IMS) network. In addition, network 102 may functionally comprise a telephony network, e.g., an Internet Protocol/Multi-Protocol Label Switching (IP/MPLS) backbone network utilizing Session Initiation Protocol (SIP) for circuit-switched and Voice over internet Protocol (VoIP) telephony services. Network 102 may further comprise a broadcast television network, e.g., a traditional cable provider network or an internet Protocol Television (IPTV) network, as well as an Internet Service Provider (ISP) network. In one example, network 102 may include a plurality of television (TV) servers (e.g., a broadcast server, a cable head-end), a plurality of content servers, an advertising server (AS), an interactive TV/video on demand (VoD) server, and so forth.

In one example, the access networks 120 and 122 may comprise broadband optical and/or cable access networks, Local Area Networks (LANs), wireless access networks (e.g., an IEEE 802.11/Wi-Fi network and the like), cellular access networks, Digital Subscriber Line (DSL) networks, public switched telephone network (PSTN) access networks, 3^{rd} party networks, and the like. For example, the operator of network 102 may provide a cable television service, an IPTV service, or any other types of telecommunication service to subscribers via access networks 120 and 122. In one example, the access networks 120 and 122 may comprise different types of access networks, may comprise the same type of access network, or some access networks may be the same type of access network and other may be different types of access networks. In one example, the network 102 may be operated by a telecommunication network service provider. The network 102 and the access networks 120 and 122 may be operated by different service providers, the same service provider or a combination thereof, or may be operated by entities having core businesses that are not related to telecommunications services, e.g., corporate, governmental or educational institution LANs, and the like.

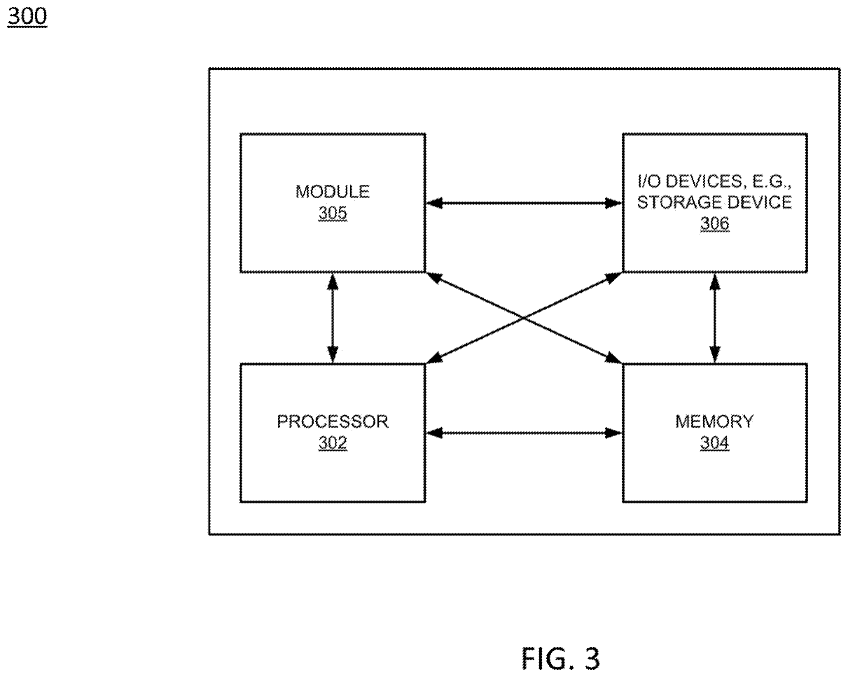

In accordance with the present disclosure, network 102 may include an application server (AS) 104, which may comprise a computing system or server, such as computing system 300 depicted in FIG. 3, and may be configured to provide one or more operations or functions in connection with examples of the present disclosure for dynamically expanding and contracting XR social environments. The network 102 may also include a database (DB) 106 that is communicatively coupled to the AS 104.

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure. Thus, although only a single application server (AS) 104 and single database (DB) are illustrated, it should be noted that any number of servers may be deployed, and which may operate in a distributed and/or coordinated manner as a processing system to perform operations in connection with the present disclosure.

In one example, AS 104 may comprise a centralized network-based server for generating extended reality environments. For instance, the AS 104 may host an application that renders immersive, social XR environments which are accessible by users utilizing various user endpoint devices. In one example, the AS 104 may be configured to monitor social interactions among users in the social XR environments and to dynamically adjust the social XR environments in response to the social interactions. For instance, the AS 104 may expand a portion of a social XR environment, contract a portion of a social XR environment, split a portion of a social XR environment, merge a portion of a social XR environment, add, delete, or change virtual objects present in a portion of a social XR environment, and make other changes to accommodate the social interactions.

In one example, AS 104 may comprise a physical storage device (e.g., a database server), to store sets of rules for difference zones of different XR environments. For instance, the AS 104 may store an index, where the index maps each zone of an XR environment to a set of statistical norms for the XR environment, where the statistical norms may define thresholds on the number of users that the zone can accommodate at any one time, the types of interactions the zone is intended to facilitate, and the like. In one example, the index may further map each zone to a set of permitted adjustments (or forbidden adjustments). For instance, the index may indicate whether a zone is permitted to be expanded to accommodate additional users or whether the size of the zone is fixed.

In a further example, the AS 104 may also store user profiles which may specify user social preferences and behaviors that can be used to determine where in an existing social XR environment to place a new user. For instance, the profile may include a measure of the new user's social engagement behaviors (e.g., degree to which the new user participates or interacts with other users in social XR environments), where the measure may be derived from the new user's historical XR experiences. The new user may also specify in the profile a level of social engagement that is desirable or comfortable for him or her. For instance, the new user may select a position along some scale or spectrum that correlates with a desired or comfortable level of social engagement (e.g., five on a scale from one to ten, where one correlates to a lowest level of social engagement and ten correlates to a highest level of social engagement). The profile may also indicate whether the new user enjoys interacting with strangers or prefers to interact with people with whom the new user is already familiar, and may further indicate identifiers for other users who the new user knows. The profile may further indicate the new user's age, occupation, schools attended, interests, and other personal data that may be relevant in facilitating social interactions within the XR environment.

A user profile may also specify baseline measures for one or more biometric indicators, where the baseline measures may be calibrated to a baseline which indicates that the given user is engaged or paying attention. Thus, deviations from the baseline measures may indicate that the given user is not engaged or that the user's attention is wandering or unfocused. This may allow the AS 104 to monitor the engagement of specific users in the XR environment.

In one example, the DB 106 may store the index and/or the user profiles, and the AS 104 may retrieve the index and/or user profiles from the DB 106 when needed. For ease of illustration, various additional elements of network 102 are omitted from FIG. 1.

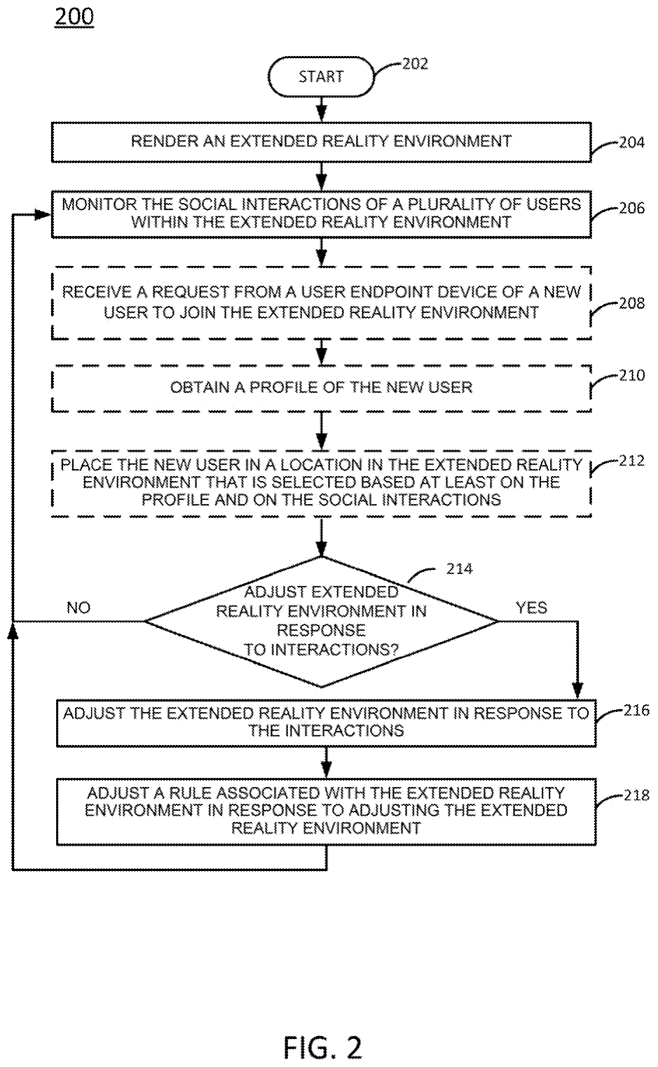

In one example, access network 122 may include an edge server 108, which may comprise a computing system or server, such as computing system 300 depicted in FIG. 3, and may be configured to provide one or more operations or functions for dynamically expanding and/or contracting XR social environments, as described herein. For instance, an example method 200 for dynamically expanding and/or contracting XR social environments is illustrated in FIG. 2 and described in greater detail below.

In one example, application server 104 may comprise a network function virtualization infrastructure (NFVI), e.g., one or more devices or servers that are available as host devices to host virtual machines (VMs), containers, or the like comprising virtual network functions (VNFs). In other words, at least a portion of the network 102 may incorporate software-defined network (SDN) components. Similarly, in one example, access networks 120 and 122 may comprise “edge clouds,” which may include a plurality of nodes/host devices, e.g., computing resources comprising processors, e.g., central processing units (CPUs), graphics processing units (GPUs), programmable logic devices (PLDs), such as field programmable gate arrays (FPGAs), or the like, memory, storage, and so forth. In an example where the access network 122 comprises radio access networks, the nodes and other components of the access network 122 may be referred to as a mobile edge infrastructure. As just one example, edge server 108 may be instantiated on one or more servers hosting virtualization platforms for managing one or more virtual machines (VMs), containers, microservices, or the like. In other words, in one example, edge server 108 may comprise a VM, a container, or the like.

In one example, the access network 120 may be in communication with a server 110. Similarly, access network 122 may be in communication with one or more devices, e.g., a user endpoint device 112. Access networks 120 and 122 may transmit and receive communications between server 110, user endpoint device 112, application server (AS) 104, other components of network 102, devices reachable via the Internet in general, and so forth. In one example, user endpoint device 112 may comprise a mobile device, a cellular smart phone, a wearable computing device (e.g., smart glasses, smart goggles, a virtual reality (VR) headset or other types of head mounted display, or the like), a laptop computer, a tablet computer, or the like (broadly an “XR device”). In one example, user endpoint device 112 may comprise a computing system or device, such as computing system 300 depicted in FIG. 3, and may be configured to provide one or more operations or functions in connection with examples of the present disclosure for dynamically expanding and contracting XR social environments.

In one example, server 110 may comprise a network-based server for generating XR environments. In this regard, server 110 may comprise the same or similar components as those of AS 104 and may provide the same or similar functions. Thus, any examples described herein with respect to AS 104 may similarly apply to server 110, and vice versa. In particular, server 110 may be a component of an XR system operated by an entity that is not a telecommunications network operator. For instance, a provider of an XR system may operate server 110 and may also operate edge server 108 in accordance with an arrangement with a telecommunication service provider offering edge computing resources to third-parties. However, in another example, a telecommunication network service provider may operate network 102 and access network 122, and may also provide an XR system via AS 104 and edge server 108. For instance, in such an example, the XR system may comprise an additional service that may be offered to subscribers, e.g., in addition to network access services, telephony services, traditional television services, and so forth.

In an illustrative example, an XR system may be provided via AS 104 and edge server 108. In one example, a user may engage an application on user endpoint device 112 (e.g., an “XR device”) to establish one or more sessions with the XR system, e.g., a connection to edge server 108 (or a connection to edge server 108 and a connection to AS 104). In one example, the access network 122 may comprise a cellular network (e.g., a 4G network and/or an LTE network, or a portion thereof, such as an evolved Uniform Terrestrial Radio Access Network (eUTRAN), an evolved packet core (EPC) network, etc., a 5G network, etc.). Thus, the communications between user endpoint device 112 and edge server 108 may involve cellular communication via one or more base stations (e.g., eNodeBs, gNBs, or the like). However, in another example, the communications may alternatively or additional be via a non-cellular wireless communication modality, such as IEEE 802.11/Wi-Fi, or the like. For instance, access network 122 may comprise a wireless local area network (WLAN) containing at least one wireless access point (AP), e.g., a wireless router. Alternatively, or in addition, user endpoint device 112 may communicate with access network 122, network 102, the Internet in general, etc., via a WLAN that interfaces with access network 122.

In the example of FIG. 1, user endpoint device 112 may establish a session with edge server 108 for accessing or joining an XR environment. For illustrative purposes, the XR environment may be a virtual escape room. In this regard, an example XR environment 114 is illustrated in FIG. 1.

In one example, the XR environment 114 may be viewed by a user through the user endpoint device 112, e.g., on a display of a head mounted display or mobile phone, or through a set of smart glasses. As the user moves through the XR environment 114, the user endpoint device 112 (or alternatively the AS 104, edge server 108, or server 110) may detect one or more virtual items and/or avatars of other users with which the user may interact. For instance, in the example of FIG. 1, the user 116 may interact with the avatars of other users 118 as well as with virtual items 124 and 126.

The XR environment 114 may be configured to accommodate three users as shown in FIG. 1. That is, the size of the XR environment 114 and the number of virtual items 124 and 126 within the XR environment 114 may be specifically configured to allow up to three users to comfortably move about the space and work together to solve puzzles. However, if a fourth user wished to join the XR environment, the four users may no longer find that they can comfortably move about the space or that there are enough virtual objects for everyone to examine for clues. Thus, in this case, the AS 104 might expand the XR environment 114 by making the dimensions of the virtual escape room larger and/or by adding new virtual objects into the virtual escape room. In other examples, however (e.g., where the users 116 and 118 do not appear to be working together or interacting with each other), the AS 104 may contract the XR environment 114 by making the dimensions of the virtual escape room smaller and/or by removing virtual objects.

It should also be noted that the system 100 has been simplified. Thus, it should be noted that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, a content distribution network (CDN) and the like. For example, portions of network 102, access networks 120 and 122, and/or Internet may comprise a content distribution network (CDN) having ingest servers, edge servers, and the like for packet-based streaming of video, audio, or other content. Similarly, although only two access networks, 120 and 122 are shown, in other examples, access networks 120 and/or 122 may each comprise a plurality of different access networks that may interface with network 102 independently or in a chained manner. In addition, as described above, the functions of AS 104 may be similarly provided by server 110, or may be provided by AS 104 in conjunction with server 110. For instance, AS 104 and server 110 may be configured in a load balancing arrangement, or may be configured to provide for backups or redundancies with respect to each other, and so forth. Thus, these and other modifications are all contemplated within the scope of the present disclosure.

To further aid in understanding the present disclosure, FIG. 2 illustrates a flowchart of a method 200 for dynamically expanding and contracting extended reality social environments in accordance with the present disclosure. In particular, the method 200 provides a method by which an extended reality environment may be adjusted in response to or to facilitate desired social interactions. In one example, the method 200 may be performed by an XR server that is configured to generate XR environments, such as the AS 104 or server 110 illustrated in FIG. 1. However, in other examples, the method 200 may be performed by another device, such as the processor 302 of the system 300 illustrated in FIG. 3. For the sake of example, the method 200 is described as being performed by a processing system.

The method 200 begins in step 202. In step 204, the processing system may render an extended reality (XR) environment. In one example, the XR environment may comprise an immersive entertainment experience, such as a video game or a movie. In another example, the XR environment may comprise a virtual professional or social event, such as a virtual meeting, a virtual conference, a virtual networking event, a virtual sporting event (e.g., in which users can “virtually” attend a game that is actually occurring or that has actually occurred elsewhere), a virtual party, a virtual concert, a virtual escape room, a virtual life event (e.g., wedding, birthday party, bar or bat mitzvah, baby shower, family or school reunion, etc.), or the like.

As discussed above, the XR environment may be an environment that combines images or elements of the real world with digital or “virtual” elements. In one example, at least some of the virtual elements may be interactive, such that a user may interact with the virtual elements to trigger some action or event. For instance, if the XR environment comprises a virtual escape room, the XR environment may include virtual items (e.g., pictures on a wall, items on a shelf, pieces of furniture, etc.) that can be examined by users for clues, virtual “locks” that can be unlocked via user manipulation with the right combination or key, and the like. A user may view and interact with the XR environment using any type of device or combination of devices that is capable of displaying and exchanging signals with the XR environment, including a mobile device such as a mobile phone or tablet computer or a wearable device such as a head mounted display.

In one example, the processing system may render the XR environment by generating a digital overlay that is superimposed over a stream of images (e.g., video) of a real world environment. For instance, a wearable device such as a head mounted display may present the overlay on a display while the user is viewing the real world environment through the head mounted display. In another example, the processing system may generate an entirely digital environment in which certain elements of a real world environment (e.g., furniture, décor, buildings, vehicles, geological features, landmarks, etc.) are recreated in digital form.

In one example, the XR environment may comprise a plurality of discrete, quantized three-dimensional zones (e.g., “voxels” or volumetric pixels) that collectively form the space and define the boundaries of the XR environment. In one example, each zone of the plurality of discrete, quantized three-dimensional zones may be associated with a respective set of rules defining statistical norms for the zone. In another example, a voxel may quantize different volumes of space as determined by the different zones' characteristics. Here, the voxels for an environment in which detailed XR interactions occur (e.g., a room in which users may manipulate a lock, play a game with their hands, or the like) may utilize a different spatial quantization than an environment which is meant to be viewed from afar (e.g., a virtual sunset, beach, or archery target practice range). In this same example, a voxel may computationally expand, contract, multiply, or decimate according to the XR-based needs of the user and the environment. In one example, the rules may define user behaviors, actions, and/or objects that are statistically determined, through observation, to represent a norm or baseline for user behaviors, actions, and or objects within the zone. For instance, a statistical norm for a zone may define a minimum and/or maximum number of users who may be “present” within the zone, a minimum or maximum desired frequency of user interactions with each other within the zone (e.g., how frequently the users present within the zone talk to each other), a minimum or maximum desired frequency of user interactions with objects present within the zone (e.g., how frequently the users present within the zone interact with or look at virtual objects in the zone), and the like.

In step 206, the processing system may monitor the social interactions of a plurality of users within the extended reality environment. For instance, in one example, the processing system may monitor the communications exchanged between users, where the communications may include video, audio, and/or text-based messages, among other types of communications. In one example, monitoring the social interactions may involve monitoring for content of the social interactions which may indicate a need to adjust the XR environment (e.g., a user suggesting “Let's have a sidebar” to another user may indicate that a new, more private area of the XR environment should be created for the users' social interactions).

In another example, the processing system may not necessarily monitor the content of the communications, but may monitor the communications to extract behavioral patterns of the users. For instance, by monitoring the communications exchanged between users, the processing system may be able to identify with which other users a given user (e.g., a first user) is exchanging communications, how many communications have been exchanged with the other users, how frequently communications are exchanged with the other users, times since last communications exchanged with the other users, and the like. Thus, the processing system may be able to identify patterns in the given user's interactions with other users as well as detect patterns in the overall interactions among the plurality of users, and further detect when interactions may deviate from the identified patterns (e.g., a first user and a second user may have exchanged twenty messages over a two-minute time period, but haven't exchanged any messages in the last ten minutes, or a third user and a fourth user may have spent the entire time in the XR environment exchanging messages with each other but not with anyone else).

In a further example, the social interactions may include non-conversational social interactions (e.g., interactions involving location and movement) from which the processing system may be able to detect conditions within the XR environment. For instance, if the processing system detects that a user has virtually “bumped” into another user in the XR environment, this may indicate that the XR environment is too small for the current number of users.

In a further example, the processing system may monitor the engagement of a given user (e.g., a first user) in the XR environment. For instance, the processing system may monitor other users with whom the given user has made eye contact (as well as how many times and for how long eye contact was made), virtual items that the given user has touched or manipulated, whether the given user is paying attention to another user or item or appears to be distracted (which may be determined, for instance, based on whether the given user is looking at or looking away from the another user or item, whether the given user appears to be engaged in some other activities such as checking his or her phone or talking to someone else, and by other means).

In a further example, the processing system may monitor biometric indicators of a given user (e.g., a first user) in the XR environment. For instance, the processing system may receive data from one or more sensors attached to or located within some physical proximity to the given user, where the sensors measure one or more biometric indicators of the given user. In one example, these sensors include sensors to measure the given user's pulse rate, pupil dilation, skin conductivity, blood pressure, breathing rate, body temperature, and/or other biometrics. In one example, the given user may be associated with a profile which may include baseline measures for the one or more biometric indicators, where the baseline measures may be calibrated to a baseline which indicates that the given user is engaged or paying attention. Thus, deviations from the baseline measures may indicate that the given user is not engaged or that the user's attention is wandering or unfocused. In one example, the sensors may include sensors that are integrated in a wearable device (e.g., smart watch, fitness tracker, head mounted display, etc.), that are integrated in a user endpoint device (e.g., smart phone, tablet computing device, etc.), or standalone sensors (e.g., cameras mounted on a wall, motion sensors positioned within a room, etc.).

It should be noted that the plurality of users may comprise a plurality of human users, or a combination of human users and “bots” (i.e., software programs that are programmed to imitate certain behaviors of human users). For instance, the XR environment may include one or more bots to help enforce the rules associated with a zone of the XR environment. As an example, if the XR environment is a virtual networking event, a bot may be deployed to help introduce human users to each other or to insert questions or observations to facilitate the flow of social interactions among the human users. If the XR environment is a virtual escape room, a bot may be deployed to provide hints when a threshold period of time has elapsed since the human users last detected a clue or solved a puzzle. If the XR environment is a virtual party, a bot may be deployed to guide users to different “rooms” of the party venue in order to ensure that none of the rooms are over-utilized or underutilized.

In optional step 208 (illustrated in phantom), the processing system may receive a request from a user endpoint device of a new user to join the extended reality environment. The new user may be, for example, a user who is not currently one of the plurality of users already present in the XR environment.

In optional step 210 (illustrated in phantom), the processing system may obtain a profile for the new user. In one example, the profile may be provided with the request to join the extended reality environment. For instance, the user endpoint device of the new user may store the new user's profile locally and may transmit the profile to the processing system along with the request. In another example, the processing system may request the profile from the user endpoint device of the new user after receiving the request to join the XR environment. In another example, the processing system may use information contained in the request (e.g., a name or user ID of the new user, a device ID of the user endpoint device of the new user, or the like) to retrieve the profile from a remote or centralized storage location, such as a profile database.

In one example, the profile may specify various characteristics and/or preferences of the new user. For instance, the profile may include a measure of the new user's social engagement behaviors (e.g., degree to which the new user participates or interacts with other users in social XR environments), where the measure may be derived from the new user's historical XR experiences. The new user may also specify in the profile a level of social engagement that is desirable or comfortable for them. For instance, the new user may select a position along some scale or spectrum that correlates with a desired or comfortable level of social engagement (e.g., five on a scale from one to ten, where one correlates to a lowest level of social engagement and ten correlates to a highest level of social engagement). The profile may also indicate whether the new user enjoys interacting with strangers or prefers to interact with people with whom the new user is already familiar, and may further indicate identifiers for other users who the new user knows. The profile may further indicate the new user's age, occupation, schools attended, interests, and other personal data that may be relevant in facilitating social interactions within the XR environment.

In optional step 212 (illustrated in phantom), the processing system may place the new user in a location in the extended reality environment that is selected based at least in part on the profile of the new user and/or on the social interactions of the plurality of users who are already present in the extended reality environment. For instance, the processing system may match the historical or desired level of social engagement indicated in the new user's profile to a location within the XR environment where the current social interactions most closely match the historical or desired level of social engagement. As an example, if the new user's profile indicates that the new user prefers to interact with other users who the new user already knows, then the processing system may elect to place the new user in a location where one of the new user's friends or family members is present. As another example, if the new user's profile indicates that the new user is a fan of a specific baseball team, then the processing system may elect to place the new user in a location where other users are discussing the specific baseball team or baseball in general. The processing system may also take into account the statistical norms associated with the zones of the XR environment when determining where to place the new user. For instance, the processing system may determine that it is not appropriate to place the new user in a zone that already contains the maximum number of users for the zone.

In step 214, the processing system may determine whether to adjust the extended reality environment in response to the social interactions of the plurality of users (which may or may not have shifted in response to the new user joining the extended reality environment). In one example, an adjustment to the XR environment may comprise an adjustment of the size of the XR environment (e.g., expanding or contracting, or even splitting or merging, one or more zones within the XR environment). In another example, an adjustment to the XR environment may comprise an adjustment to a number of objects that are present in the XR environment. In another example, an adjustment to the XR environment may comprise an exchange of one or more existing objects for one or more new objects.

In one example, the processing may determine that the XR environment should be adjusted when the social interactions of the plurality of users in any given zone of the plurality of discrete, quantized zones making up the XR environment deviate by more than a threshold from the statistical norm for the given zone. For instance, if the zone is associated with a maximum (threshold) number of users, and the current number of users attempting to interact with or within the zone is greater than the maximum, then the processing system may determine that the zone should be expanded or enlarged, or even split into multiple zones, to accommodate the users. Additionally, if the zone includes a plurality of tables for the users to sit at (e.g., as might be the case where the XR environment comprises a virtual conference or cocktail party), the processing system may determine that a number of tables present in the zone should be increased to accommodate the users.

Similarly, if the number of users currently interacting with or within the zone is within an acceptable range (e.g., not below a minimum threshold or above a maximum threshold), but the number of interactions between the users is below a minimum threshold, then the processing system may determine that the zone should be contracted or shrunk, or even merged with another zone, to encourage more interaction among the users. Additionally, if the zone includes a plurality of tables for the users to sit at (e.g., as might be the case where the XR environment comprises a virtual conference or cocktail party), the processing system may determine that a number of chairs (e.g., vacant chairs) at the tables should be reduced or deleted to remove space between users and encourage more interaction.

In another example, if the type of user actions or behaviors observed within the zone changes, then the processing system may exchange or replace one or more existing objects in the zone with one or more new objects to accommodate the changed actions or behaviors. For instance, if the users were previously seated at tables, but then a threshold number of users get up to dance (e.g., as might be the case where the XR environment comprises a virtual wedding reception, reunion, or the like), then the processing system may determine that at least some of the tables that were present in the zone should be replaced with a dancefloor.

If the processing system determines in step 214 that the extended reality environment should not be adjusted in response to the social interactions of the plurality of users, then the method 200 may return to step 206, and the processing system may continue to simply monitor the social interactions of the plurality of users. If, however, the processing system determines in step 214 that the extended reality environment should be adjusted in response to the social interactions of the plurality of users, then the method 200 may proceed to step 216.

In step 216, the processing system may adjust the extended reality environment in response to the social interactions of the plurality of users. As discussed above, adjusting the XR environment may involve adjusting a size of at least one zone of the XR environment, or adding, deleting, or replacing one or more virtual objects in at least one zone of the XR environment.

In one example, where the adjustment to the XR environment comprises splitting a zone of the XR environment, the splitting may be done in a manner that attempts to preserve any ongoing social interactions within the zone. For instance, the zone may comprise a room of a venue hosting a virtual party. The processing system may determine that the number of users within the zone exceeds a maximum threshold number of users for the zone, and that some of the users should be moved to a newly created or existing (but perhaps currently underutilized) zone. In this case, the processing system may identify subgroups within the number of users, where different subgroups may be independently engaged in different interactions. For instance, a first subgroup of users may be determined to be looking at a user who is talking (e.g., telling a story), while a second subgroup of users may be determined to not be looking at the user who is talking or to be engaged in a separate conversation. Thus, the processing system may elect to keep all of the users in the first subgroup within the current zone, but to move all of the users in the second subgroup to a different zone. In one example, the processing system may provide a warning to users who are being moved before moving those users. The processing system may also provide a warning to users who are not being moved to alert the users to the fact that other users are being moved. In a further example, the processing system may ask for users to volunteer to be moved, and may recommend different zones that may be suitable for any users who volunteer, based on the volunteering users' profiles.

In another example, where the adjustment of the XR environment comprises contracting or shrinking a zone, the layout or appearance of the zone as it appears visually to users may change. For instance, the zone may comprise a room of a venue hosting a virtual party. The processing system may determine that the number of users within the zone is below a minimum threshold number of users for the zone, and that the zone should be shrunk to bring the users within closer proximity to each other to encourage social engagement. In this case, the processing system may move virtual walls of the zone closer together to simulate the effect of a room shrinking, may delete superfluous objects within the zone (e.g., empty or nearly empty tables or chairs, underutilized interactive objects, etc.), and the like. The processing system may provide a warning to the users within the zone prior to rendering any such adjustments which can be implemented over a period of time, e.g., within a five-minute period, within a ten-minute period and so on.

In another example, where the adjustment of the XR environment comprises expanding a zone, the layout or appearance of the zone as it appears visually to users may change. For instance, the zone may comprise a room of a venue hosting a virtual party. The processing system may determine that the number of users within the zone exceeds a maximum threshold number of users for the zone, and that the zone should be expanded to accommodate all of the users. In this case, the processing system may move virtual walls of the zone further apart to simulate the effect of a room expanding, may add new objects within the zone (e.g., additional tables or chairs or interactive objects, etc.), and the like. Adjustments may also be made to visually connect the adjusted zone to other zones within the XR environment (e.g., doors or hallways to underutilized zones may be added or opened, a map or navigation widget may be added, etc.). The processing system may provide a warning to the users within the zone prior to rendering any such adjustments which again can be implemented over a period of time, e.g., within a five-minute period, within a ten-minute period and so on.

In step 218, the processing system may adjust a rule associated with the XR environment in response to adjusting the extended reality environment. For instance, the rule may be a rule associated with a zone of the plurality of discrete, quantized three-dimensional zones into which the XR environment is divided. For instance, prior to adjusting the XR environment, the rule associated with a given zone may have indicated that the maximum number of user that could be present in the given zone at any time was four. However, the adjusting of the XR environment may have involved expanding the given zone to accommodate more users; thus, the rule associated with the given zone may be adjusted to reflect that the given zone can now accommodate a larger maximum number of users, e.g., five users, six users and so on.

In one example, the processing system may only adjust the rules for any zones that are adjusted in step 216. In another example, however, the processing system may adjust the rules for all zones of the plurality of zones, as an adjustment to one zone may necessitate or cause changes to the statistical norms associated with other zones. For instance, an XR environment may be configured to present a virtual escape room. In this case, the XR environment may include a first zone that is arranged as first room and a second zone that is arranged as a second room which can only be accessed by solving clues to “unlock” a door between the first room and the second room. If the first zone is expanded to accommodate a greater number of users, then this may imply that the second zone will also need to accommodate the same greater number of users and thus should be similarly expanded, e.g., prior to the users entering the second zone.

In another example, the XR environment may comprise a single “room” or venue, where a specific zone of the room may be resized in response to an event occurring in that specific zone. For instance, the XR environment may be configured as a virtual wedding reception, and the bride and groom may be sharing their first dance within a first zone of the virtual wedding reception (e.g., the dancefloor or a part of the dancefloor). In this case, the first zone may be resized so that all of the wedding guests can have a clear view of the dance. In another example, the XR environment may comprise a virtual sporting event, and a well-known actor may be spotted in the “crowd” at the event. In this case, a zone surrounding the actor could be resized to draw attention to the actor's presence. In both of the above examples, the effects on the XR environment may be different from the effects of simply expanding or contracting an entire environment or “room,” because the size of an avatar or object in a resized zone may also change.

The method 200 may then return to step 206, and the processing system may continue to monitor the social interactions of the plurality of users within the extended reality environment, taking any further steps when and as determined necessary. Thus, examples of the present disclosure may dynamically adjust an XR environment in an opportunistic and need-based manner that is responsive to the context of an activity occurring in the XR environment and the social norms of the activity, without requiring users to explicitly request the adjustment. For instance, in one example, the size of at least a portion of the XR environment may be adjusted (e.g., expanded, contracted, split, or merged) in response to social need (e.g., to present a realistic and immersive view in XR that matches a user's viewpoint of what the environment should contain). In another example, the size of at least a portion of the XR environment may be adjusted in response to a change in the activity occurring in the XR environment (e.g., to provide the physiological space and/or objects necessary to accommodate the activity). In another example, the distribution of users in the XR environment may be adjusted in response to social cohort and interaction needs (e.g., to balance out the number of users participating in certain activities within the XR environment).

The ability to dynamically adjust the sizes of, and objects within, XR environments may have a number of applications in the XR field. For instance, examples of the present disclosure could be used to manage personality characteristics of users and to learn rule sets for different groups of users. This may allow an XR system to improve socialization among users, e.g., by “breaking the ice” for larger initial groups. This may also allow the XR system to minimize sparsity among groups of users, which can detract from the user experience. In addition, this may allow the XR environment to resize the XR environment for different groups that users can join. For instance, the XR environment may not be expanded until all groups within the XR environment include a minimum number of users.

Further examples of the present disclosure may be implemented to auto-generate new space in an XR environment for more activities (e.g., to accommodate an activity that involves a wide range of motion, such as swinging a weapon in a video game or exercising in a virtual fitness class). In one example, the XR system may create extra distance between users (or user avatars) for safety purposes as the types of activities in which the users are engaged changes (e.g., from standing still to dancing or practicing martial arts). For new activities, the XR system may create special zones (e.g., zones for video game battles) and may notify the users of their membership in particular zones.

Further examples of the present disclosure may be used to implement flexible sizing for virtual conference scenarios based on topic appropriateness. For instance, separate tables may be rendered in a virtual conference space for separate group discussions or for discussions that emerge.

Further examples of the present disclosure may be used to expand and contract virtual classrooms in response to student learning needs and speeds. For instance, an XR environment could implement automatic striation of group learning environments in massive open online courses. In this case, faster learners could be assigned to a first zone of the XR environment, deep learners could be assigned to a second zone of the XR environment, visual learners could be assigned to a third zone of the XR environment, auditory learners could be assigned to a fourth zone of the XR environment, and so on.

Although not expressly specified above, one or more steps of the method 200 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

Examples of the present disclosure may also have commercial applications. For instance, in an ecommerce context, an advertiser may pay for advertisements to be placed in an XR environment (e.g., on a virtual billboard or other space). In this case, smaller, more discreet advertisements may be targeted to the most active or engaged users in the XR environment rather than targeting larger, more conspicuous advertisements to all users. The XR environment may also be configured as an ecommerce environment (e.g., a virtual store) that can change size and layout to accommodate customer needs.

In further examples still, the ability to expand the XR environment may be limited by cost or connectivity. For instance, an XR system may host XR environments for various customers as a pay service. A budget for a particular XR environment may dictate that the size of the XR environment cannot be expanded beyond a predetermined maximum size (unless the budget is also adjusted). Similarly, the connectivity constraints (e.g., throughput) of the XR system may limit the amount by which the XR environment can be expanded. For instance, the throughput demands associated with a conference room designed to accommodate less than ten people may be different than the throughput demands associated with a conference hall designed to accommodate two hundred people.

FIG. 3 depicts a high-level block diagram of a computing device specifically programmed to perform the functions described herein. For example, any one or more components or devices illustrated in FIG. 1 or described in connection with the method 200 may be implemented as the system 300. For instance, a server (such as might be used to perform the method 200) could be implemented as illustrated in FIG. 3.

As depicted in FIG. 3, the system 300 comprises a hardware processor element 302, a memory 304, a module 305 for dynamically expanding and contracting the XR social environments, and various input/output (I/O) devices 306.

The hardware processor 302 may comprise, for example, a microprocessor, a central processing unit (CPU), or the like. The memory 304 may comprise, for example, random access memory (RAM), read only memory (ROM), a disk drive, an optical drive, a magnetic drive, and/or a Universal Serial Bus (USB) drive. The module 305 for dynamically expanding and contracting the XR social environments may include circuitry and/or logic for performing special purpose functions relating to the operation of a home gateway or XR server. The input/output devices 306 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for dynamically expanding and contracting the XR social environments (e.g., a software program comprising computer-executable instructions) can be loaded into memory 304 and executed by hardware processor element 302 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for dynamically expanding and contracting the XR social environments (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
rendering, by a processing system including at least one processor, an extended reality environment;
monitoring, by the processing system, social interactions of a plurality of users within the extended reality environment;
adjusting, by the processing system, the extended reality environment in response to the social interactions of the plurality of users; and
adjusting, by the processing system, a rule associated with the extended reality environment in response to the adjusting the extended reality environment.

2. The method of claim 1, wherein the extended reality environment is at least one of: an immersive entertainment experience, a virtual professional event, or a virtual social event.

3. The method of claim 1, wherein the extended reality environment comprises a plurality of discrete, quantized three-dimensional zones, and wherein each zone of the plurality of discrete, quantized three-dimensional zones is associated with a respective set of rules defining statistical norms for the each zone.

4. The method of claim 3, wherein the monitoring comprises monitoring a number of users present within a first zone of the plurality of discrete, quantized three-dimensional zones.

5. The method of claim 4, wherein the adjusting the extended reality environment comprises expanding a size of the first zone when the number of users present within the first zone exceeds a threshold number defined by the respective set of rules associated with the first zone.

6. The method of claim 4, wherein the adjusting the extended reality environment comprises contracting a size of the first zone when the number of users present within the first zone falls below a threshold number defined by the respective set of rules associated with the first zone.

7. The method of claim 3, wherein the monitoring comprises monitoring communications exchanged among the plurality of users.

8. The method of claim 7, wherein the monitoring determines at least one of: which users of the plurality of users are exchanging the communications, a number of the communications, a frequency of the communications, or a time elapsed since a last communication of the communications was exchanged.

9. The method of claim 8, wherein the adjusting comprises contracting a size of the first zone to encourage the plurality of users to exchange more communications.

10. The method of claim 3, wherein the monitoring comprises monitoring biometric indicators of the plurality of users to measure respective levels of engagement of the plurality of users.

11. The method of claim 3, wherein the rule associated with the extended reality environment is a part of the respective set of rules associated within one zone of the plurality of discrete, quantized three-dimensional zones.

12. The method of claim 1, wherein at least one user of the plurality of users is a bot programmed to enforce the rule.

13. The method of claim 1, wherein the adjusting the extended reality environment comprises making a change to a virtual object that is present in the extended reality environment.

14. The method of claim 1, wherein the adjusting the rule comprises adjusting a maximum number of users accommodated by a portion of the extended reality environment.

15. The method of claim 1, wherein the adjusting the rule comprises adjusting a minimum number of users accommodated by a portion of the extended reality environment.

16. The method of claim 1, further comprising:
receiving, by the processing system from a user endpoint device of a new user, a request to join the extended reality environment.

17. The method of claim 16, wherein the processing system selects a location in the extended reality environment in which to place the new user based on at least one of: a profile of the new user or on the social interactions of the plurality of users.

18. The method of claim 17, wherein the profile of the new user specifies an interaction preference of the new user.

19. A non-transitory computer-readable medium storing instructions which, when executed by a processing system including at least one processor, cause the processing system to perform operations, the operations comprising:
rendering an extended reality environment;
monitoring social interactions of a plurality of users within the extended reality environment;
adjusting the extended reality environment in response to the social interactions of the plurality of users; and
adjusting a rule associated with the extended reality environment in response to the adjusting the extended reality environment.

20. A device comprising:
a processing system including at least one processor; and
a computer-readable medium storing instructions which, when executed by the processing system, cause the processing system to perform operations, the operations comprising:
rendering an extended reality environment;
monitoring social interactions of a plurality of users within the extended reality environment;
adjusting the extended reality environment in response to the social interactions of the plurality of users; and
adjusting a rule associated with the extended reality environment in response to the adjusting the extended reality environment.
